(19) United States
(12) Patent Application Publication
(10) Pub. No.: US 2022/0112933 A1
(43) Pub. Date: Apr. 14, 2022

(54) SHOCK ABSORBER

(71) Applicant: Hitachi Astemo, Ltd., Ibaraki (JP)

(72) Inventors: Koichi YAMAKA, Ibaraki (JP); Riichi NAGAO, Tokyo (JP)

(21) Appl. No.: 17/417,512

(22) PCT Filed: Nov. 13, 2019
(86) PCT No.: PCT/JP2019/044551

§ 371 Date: Jun. 23, 2021

(30) Foreign Application Priority Data
Dec. 27, 2018 (JP) 2018-245972

(51) Int. Cl. F16F 9/32; F16F 9/18

(52) U.S. Cl. CPC F16F 9/3271; F16F 9/185; F16F 9/3242; B60G 13/08; F16F 2234/02; F16F 2232/08; F16F 2222/12; F16F 9/3257

(57) ABSTRACT

A protruding portion includes a fitting portion to which an outer periphery of a cylinder is fitted. When the cylinder and a closing member are assembled into an outer cylinder, a length from a contact portion to one end side end portion of the outer cylinder is longer than a length from the other end side end portion of the cylinder to one end side end portion on an outer peripheral side of the closing member. A length from one end side end surface of the protruding portion to the contact portion is longer than a difference between the length from the contact portion of a bottom portion to one end side end portion of the outer cylinder and the length from the other end side end portion of the cylinder to one end side end portion on the outer peripheral side of the closing member.

### TECHNICAL FIELD

The present invention relates to a shock absorber.

Priority is claimed on Japanese Patent Application No. 2018-245972, filed on Dec. 27, 2018, the content of which is incorporated herein by reference.

### BACKGROUND ART

There is a shock absorber having a cylinder and an outer cylinder that covers the cylinder (for example, refer to Patent Document 1).

### CITATION LIST

### Patent Document

[Patent Document 1]

Japanese Patent No. 5798842

### SUMMARY OF INVENTION

### Technical Problem

It is desired to suppress defective assembly in a shock absorber.

The present invention provides a shock absorber capable of suppressing defective assembly.

### Solution to Problem

According to an aspect of the present invention, a shock absorber includes a rod having one end side protruding outward, a cylinder having a cylindrical shape, an outer cylinder having a bottom portion provided on the other end side, disposed on an outer peripheral side of the cylinder to form a reservoir chamber between the cylinder and the outer cylinder, a closing member that closes an opening of the cylinder on one end side and an opening of the outer cylinder on one end side, a plurality of protruding portions extending in an axial direction of the cylinder from the bottom portion, protruding inward in a radial direction of the cylinder from an inner peripheral surface of the outer cylinder, and provided apart from each other in a circumferential direction of the cylinder, and a contact portion provided in the bottom portion, and with which the other end side end portion of the cylinder comes into contact. The protruding portion includes a fitting portion to which an outer periphery of the cylinder is fitted. When the cylinder and the closing member are assembled into the outer cylinder, a length from the contact portion to one end side end portion of the outer cylinder is longer than a length from the other end side end portion of the cylinder to one end side end portion on an outer peripheral side of the closing member. A length from one end side end surface of the protruding portion to the contact portion is longer than a difference between the length from the contact portion of the bottom portion to one end side end portion of the outer cylinder and the length from the other end side end portion of the cylinder to one end side end portion on the outer peripheral side of the closing member.

### Advantageous Effects of Invention

According to the above-described shock absorber, defective assembly can be suppressed.

### BRIEF DESCRIPTION OF DRAWINGS

FIG. 1 is a longitudinal sectional view showing a shock absorber of a first embodiment according to the present invention.

FIG. 2 is a longitudinal sectional view showing a main part of the shock absorber of the first embodiment according to the present invention.

FIG. 3 is a perspective sectional view showing the main part of the shock absorber of the first embodiment according to the present invention.

FIG. 4 is a cross-sectional view showing the main part of the shock absorber of the first embodiment according to the present invention.

FIG. 5 is a perspective sectional view showing the main part of an outer cylinder of the shock absorber of the first embodiment according to the present invention.

FIG. 6 is a longitudinal sectional view showing the shock absorber of the first embodiment according to the present invention.

FIG. 7 is a longitudinal sectional view showing a main part of a shock absorber of a second embodiment according to the present invention.

FIG. 8 is a perspective sectional view showing the main part of the shock absorber of the second embodiment according to the present invention.

FIG. 9 is a perspective sectional view showing the main part of an outer cylinder of the shock absorber of the second embodiment according to the present invention.

FIG. 10 is a longitudinal sectional view showing a main part of a shock absorber of a third embodiment according to the present invention.

FIG. 11 is a perspective sectional view showing the main part of the shock absorber of the third embodiment according to the present invention.

FIG. 12 is a longitudinal sectional view showing a main part of a shock absorber of a fourth embodiment according to the present invention.

FIG. 13 is a perspective sectional view showing the main part of the shock absorber of the fourth embodiment according to the present invention.

### DESCRIPTION OF EMBODIMENTS

### First Embodiment

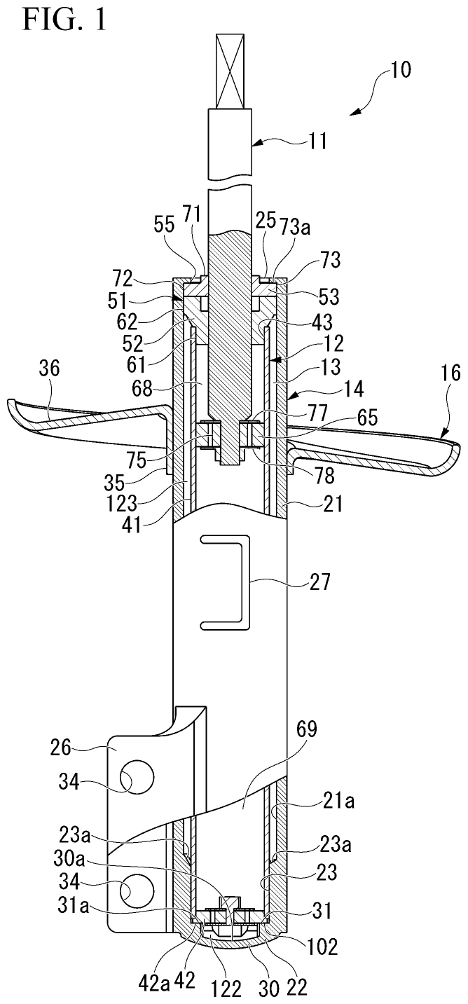

Hereinafter, a shock absorber of a first embodiment according to the present invention will be described with reference to FIGS. 1 to 6.

FIG. 1 shows the shock absorber 10 of the first embodiment. The shock absorber 10 is used for a suspension device of a vehicle such as an automobile and a railroad vehicle. Specifically, the shock absorber is used for a strut type suspension of the automobile. The shock absorber 10 has a rod 11 having one end side in an axial direction which protrudes outward. In the shock absorber 10, one end side of the rod 11 in the axial direction, which is positioned on one end side in the axial direction of the shock absorber 10, protrudes outward. In the following description, a side (upper side in FIG. 1) of the shock absorber 10 in the axial direction where the rod 11 protrudes will be referred to described as one end side in the axial direction, and a side (lower side in FIG. 1) of the shock absorber 10 in the axial direction where the rod 11 does not protrude will be referred to as the other end side in the axial direction.

The shock absorber 10 has a cylinder 12 which has a bottomed cylindrical shape and in which a working liquid serving as a working fluid is enclosed, an outer cylinder 14 which has a bottomed cylindrical shape, has a diameter larger than that of the cylinder 12, and is disposed on an outer peripheral side of the cylinder 12 to form a reservoir chamber 13, in which the working liquid and a working gas serving as the working fluid is enclosed, between the cylinder 12 and the outer cylinder 14, and a spring seat 16 which is attached to an outer peripheral side of the outer cylinder 14.

The outer cylinder 14 is an integrally molded product made of one metal member. Specifically, the outer cylinder 14 is formed by casting an aluminum alloy. The outer cylinder 14 has a side wall portion 21 which has a cylindrical shape, a bottom portion 22 which closes one end side in the axial direction of the side wall portion 21, a protruding portion 23 which protrudes inward in a radial direction of the cylinder 12 from an inner peripheral surface 21a of the side wall portion 21 on the bottom portion 22 side in the axial direction, an opening portion 25 which is provided on a side opposite to the bottom portion 22 in the axial direction of the side wall portion 21, a main bracket portion 26 which extends outward in the radial direction of the side wall portion 21 from the side wall portion 21 on the bottom portion 22 side in the axial direction of the side wall portion 21, and a stabilizer bracket portion 27 which extends outward in the radial direction of the side wall portion 21 from the side wall portion 21 and is provided at a position closer to the opening portion 25 side than the main bracket portion 26 in the axial direction of the side wall portion 21. The inner peripheral surface 21a of the side wall portion 21 is an inner peripheral surface of the outer cylinder 14. Therefore, the protruding portion 23 protrudes inward in the radial direction of the outer cylinder 14 from the inner peripheral surface of the outer cylinder 14.

The opening portion 25 is provided on one end side in the axial direction of the outer cylinder 14, and the bottom portion 22 is provided on the other end portion of the outer cylinder 14 in the axial direction. The bottom portion 22 has a bottom portion body portion 30 that closes the other end side in the axial direction of the side wall portion 21, and a contact portion 31 that protrudes to one end side in the axial direction from the bottom portion body portion 30. The bottom portion body portion 30 has a spherical plate shape curved to form a convex shape toward the other end side in the axial direction. The contact portion 31 protrudes to one end side in the axial direction from a bottom surface 30a of the bottom portion body portion 30. The cylinder 12 is in contact with the contact portion 31 of the bottom portion 22. In the outer cylinder 14, the side wall portion 21, the bottom portion 22 including the bottom portion body portion 30 and the contact portion 31, the protruding portion 23, the main bracket portion 26, and the stabilizer bracket portion 27 are molded by casting. The other end side in the axial direction of the bottom portion body portion 30 may not have a spherical plate shape curved to form the convex shape, and may have a planar plate shape having a flat shape or any other shape.

A plurality of mounting holes 34, specifically two mounting holes 34, are formed in the main bracket portion 26, and the main bracket portion 26 of the shock absorber 10 is connected to a wheel side by inserting a fastener (not shown) into the mounting holes 34. In addition, the rod 11 of the shock absorber 10 is connected to a vehicle body side. The stabilizer bracket portion 27 supports a stabilizer (not shown).

The spring seat 16 is attached to the side wall portion 21 at a position closer to the opening portion 25 side than the stabilizer bracket portion 27. The spring seat 16 is made of metal, and is fixed to an outer peripheral portion of the side wall portion 21 of the outer cylinder 14 by welding. The spring seat 16 has a spring seat fitting portion 35 fitted to an outer peripheral surface of the side wall portion 21, and a receiving portion 36 that spreads outward in the radial direction from an entire periphery of the spring seat fitting portion 35. The receiving portion 36 of the spring seat 16 receives a lower end of a spring (not shown) that supports the vehicle body. The spring seat 16 may be fixed to the outer cylinder 14 by press fitting or by using any other fixing method, instead of welding the spring seat 16 to the outer peripheral portion of the side wall portion 21 of the outer cylinder 14.

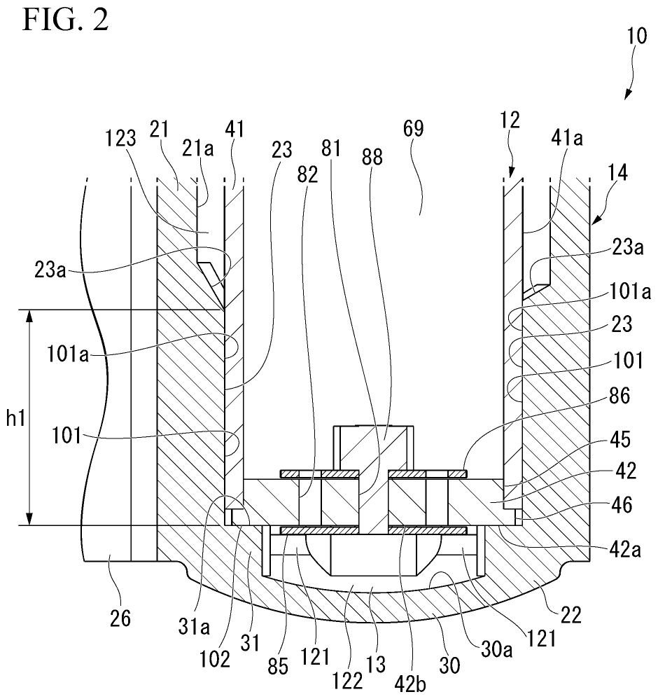

The cylinder 12 is an integrally molded product made of one metal member. The cylinder 12 has a cylinder body 41 which has a cylindrical shape and a body 42 which closes the other end side in the axial direction of the cylinder body 41, and thus the cylinder 12 has a bottomed cylindrical shape. The cylinder body 41 is provided with an opening portion 43 formed on a side opposite to the body 42. The body 42 is also an integrally molded product made of one metal member, and is formed by sintering. As shown in FIG. 2, an outer peripheral side of the body 42 has a stepped shape having a small diameter portion 45 provided on one end side in the axial direction, and a large diameter portion 46 having a diameter larger than the small diameter portion 45 and provided on the other end side in the axial direction. The small diameter portion 45 and the large diameter portion 46 are coaxially formed. An end portion on the other end side in the axial direction of the cylinder body 41 is fitted to the small diameter portion 45 of the body 42, and is in contact with the large diameter portion 46. In this way, the body 42 is attached to the end portion on the other end side in the axial direction of the cylinder body 41. An outer diameter of the large diameter portion 46 is smaller than an outer diameter of the cylinder body 41. The outer diameter of the large diameter portion 46 may be larger than the outer diameter of the cylinder body 41.

As shown in FIG. 1, the shock absorber 10 has a closing member 51 that closes the opening portion 43 provided on one end side of in the axial direction of the cylinder 12 and the opening portion 25 provided on one end side in the axial direction of the outer cylinder 14. The closing member 51 includes an annular rod guide 52 fitted to one end sides of both the cylinder 12 and the outer cylinder 14 in the axial direction, and an annular seal member 53 disposed on a side opposite to the bottom portion 22 with respect to the rod guide 52 and fitted to one end side in the axial direction of the outer cylinder 14.

The rod guide 52 has a stepped shape having a cylinder fitting portion 61 fitted to the cylinder 12 and provided on the other end side in the axial direction, and an outer cylinder fitting portion 62 having an outer diameter larger than that of the cylinder fitting portion 61, fitted to the outer cylinder 14 and provided on one end side in the axial direction. The cylinder fitting portion 61 and the outer cylinder fitting portion 62 are coaxially formed.

On the body 42 side, the cylinder body 41 of the cylinder 12 is fitted into the protruding portion 23 of the outer cylinder 14. The body 42 comes into contact with the contact portion 31 of the bottom portion 22 of the outer cylinder 14.

The opening portion 43 of the cylinder 12 is fitted to the cylinder fitting portion 61 of the rod guide 52. On the opening portion 25 side, the outer cylinder fitting portion 62 of the rod guide 52 is fitted to the side wall portion 21 of the outer cylinder 14. In this manner, the cylinder 12 is supported by the outer cylinder 14 via the rod guide 52. In this state, the cylinder 12 is coaxially disposed with respect to the outer cylinder 14, and is positioned so as not to be movable in the radial direction.

The outer cylinder 14 has a crimping portion 55 that is plastically deformed inward in the radial direction by curling, and the crimping portion 55 is provided on a side opposite to the bottom portion 22 of the side wall portion 21. The body 42 of the cylinder 12 is in contact with the contact portion 31 of the bottom portion 22 of the outer cylinder 14. In this manner, the rod guide 52 fitted to the cylinder 12 is positioned in the axial direction with respect to the outer cylinder 14. The seal member 53 is held between the rod guide 52 positioned in the axial direction with respect to the outer cylinder 14 in this way and the crimping portion 55 of the outer cylinder 14. The seal member 53 seals the opening portion 25 side of the outer cylinder 14.

The shock absorber 10 has a piston 65 provided inside the cylinder body 41 of the cylinder 12 disposed inside the outer cylinder 14. The piston 65 is slidably fitted into the cylinder body 41. The piston 65 defines a first chamber 68 and a second chamber 69 inside the cylinder 12. The first chamber 68 is provided between the piston 65 and the rod guide 52 inside the cylinder 12. The second chamber 69 is provided between the piston 65 and the body 42 inside the cylinder 12. The second chamber 69 inside the cylinder 12 and the reservoir chamber 13 are divided by the body 42 provided on the other end side in the axial direction of the cylinder 12. An oil liquid serving as a working liquid is enclosed in the first chamber 68 and the second chamber 69. A gas serving as a working gas and an oil liquid serving as a working liquid are enclosed in the reservoir chamber 13.

The other end side in the axial direction of the rod 11 is coupled to the piston 65, and one end side in the axial direction of the rod 11 extends outward from the cylinder 12 and the outer cylinder 14 via the opening portions 43 and 25. The rod 11 passes through the rod guide 52 and the seal member 53 and extends outward from the cylinder 12 and the outer cylinder 14. The rod 11 is restricted in moving in the radial direction by the rod guide 52, and moves integrally with the piston 65 in the axial direction with respect to the cylinder 12 and the outer cylinder 14. The seal member 53 closes a portion between the outer cylinder 14 and the rod 11, and restricts an outward leakage of the working liquid inside the cylinder 12 and the working gas and working liquid inside the reservoir chamber 13. The seal member 53 is provided in the opening portion 25 of the outer cylinder 14, and seals the working fluid which is enclosed in the outer cylinder 14. The seal member 53 has an inner peripheral side seal portion 71 in sliding contact with the rod 11, and an outer peripheral side seal portion 72 fitted to the outer cylinder 14. An end surface 73a of an end portion 73 (one end side end portion on an outer peripheral side of the closing member) of the outer peripheral side seal portion 72 of the seal member 53 on one end side in the axial direction comes into contact with the crimping portion 55.

A passage 75 and a passage (not shown) are formed in the piston 65 so as to penetrate the piston 65 in the axial direction.

The passage 75 and the passage (not shown) can communicate the first chamber 68 and the second chamber 69 with each other. The shock absorber 10 has an annular disc valve 77 which is provided to the piston 65 on a side opposite to the bottom portion 22 in the axial direction and is capable of closing the passage 75 by coming into contact with the piston 65. In addition, the shock absorber 10 has an annular disc valve 78 which is provided to the piston 65 on the bottom portion 22 side in the axial direction and is capable of closing the passage (not shown) by coming into contact with the piston 65 and.

When the rod 11 moves to a contraction side that increases the amount of insertion into the cylinder 12 and the outer cylinder 14 and the piston 65 moves in a direction of narrowing the second chamber 69, and the pressure in the second chamber 69 is higher than the pressure in the first chamber 68 by a predetermined value or greater, the disc valve 77 opens the passage 75 to generate a damping force. When the rod 11 moves to an extension side that increases the amount of protrusion from the cylinder 12 and the outer cylinder 14 and the piston 65 moves in a direction of narrowing the first chamber 68, and the pressure in the first chamber 68 is higher than the pressure in the second chamber 69 by a predetermined value or greater, the disc valve 78 opens the passage (not shown) to generate a damping force.

As shown in FIG. 2, a through-hole 81 is formed in a center of the body 42 of the cylinder 12 in the radial direction so as to penetrate the body 42 in the axial direction. A passage 82 and a passage (not shown) are formed in the body 42 outside the through-hole 81 in the radial direction. The passage 82 and the passage (not shown) can communicate the second chamber 69 and the reservoir chamber 13 with each other. The shock absorber 10 has an annular disc valve 85 provided to the body 42 on the bottom portion 22 side in the axial direction, and has an annular disc valve 86 provided to the body 42 on a side opposite to the bottom portion 22 in the axial direction. The disc valve 85 can close the passage 82 by coming into contact with the body 42. The disc valve 86 can close the passage (not shown) by coming into contact with the body 42. A fastener 88 for attaching the disc valves 85 and 86 to the body 42 is attached to the body 42 by being inserted into the through-hole 81.

When the rod 11 moves to the contraction side and the piston 65 moves in the direction of narrowing the second chamber 69, and the pressure in the second chamber 69 is higher than the pressure in the reservoir chamber 13 by a predetermined value or greater, the disc valve 85 opens the passage 82 to generate a damping force. When the rod 11 moves to the extension side and the piston 65 moves to the first chamber 68 side, and the pressure in the second chamber 69 is lower than the pressure in the reservoir chamber 13, the disc valve 86 opens the passage (not shown) to flow the working liquid from the reservoir chamber 13 into the second chamber 69 without substantially generating a damping force. That is, the disc valve 86 is a suction valve.

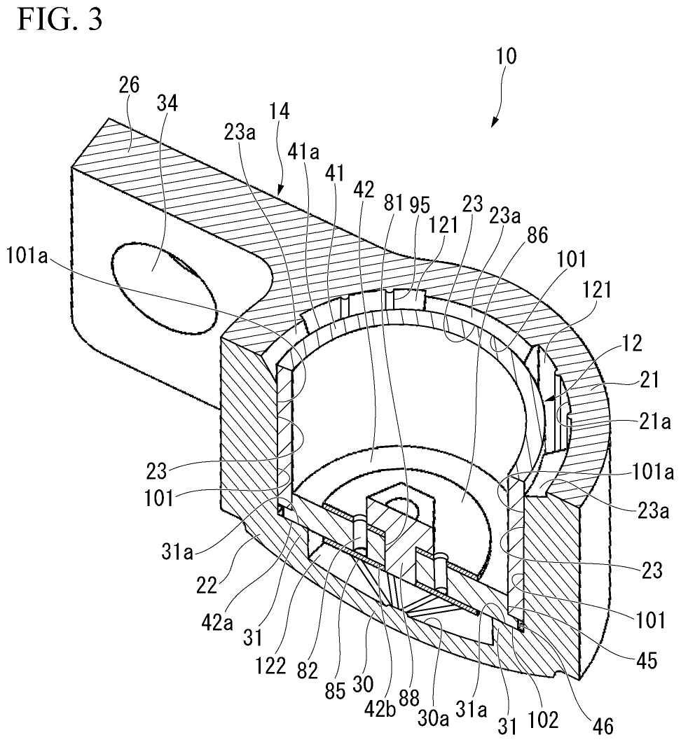

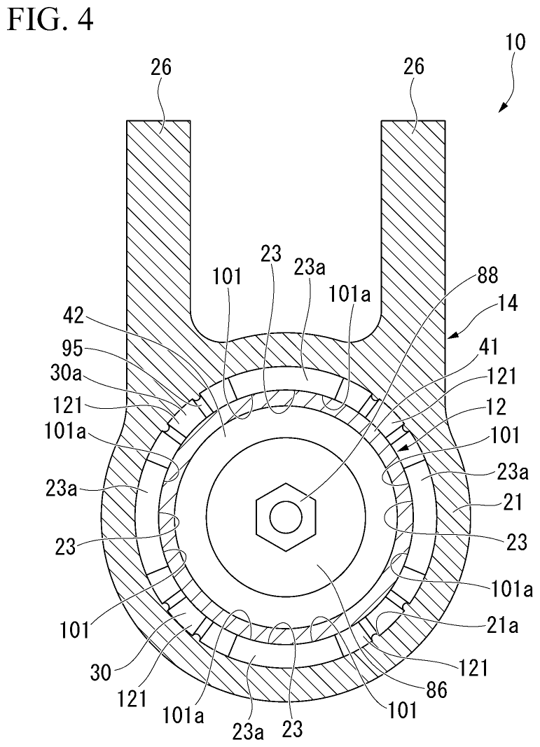

As shown in FIG. 3, in the outer cylinder 14, the protruding portion 23 protrudes inward in the radial direction of the side wall portion 21 from the inner peripheral surface 21a of the side wall portion 21. The protruding portion 23 extends from the bottom portion 22 of the outer cylinder 14 in the axial direction of the side wall portion 21. As shown in FIG. 4, the outer cylinder 14 is provided with a plurality of the protruding portions 23, specifically four protruding portions 23, which are disposed apart from each other at an equal interval in a circumferential direction of the side wall portion 21. An inner end portion of the protruding portion 23 in the radial direction of the side wall portion 21 is a fitting portion 101 serving as a fitting portion according to the present invention, to which an outer periphery of the cylinder 12 is fitted.

Each of a plurality of the fitting portions 101 include an inner end surface 101a provided on a central axis side of the side wall portion 21, and the inner end surfaces 101a are disposed on the same tapered surface, around the central axis of the side wall portion 21, which is inclined by the amount of gradient for removing from a mold.

In other words, the inner end surfaces 101a of the plurality of fitting portions 101 are disposed at positions equidistant from the central axis of the side wall portion 21. The tapered surface is inclined to be closer to the central axis of the side wall portion 21 toward the bottom portion 22 side. In other words, the tapered surface is a conical surface having a smaller diameter toward the bottom portion 22 side. There may be a gap between the cylinder 12 and the fitting portion 101 within a tolerance range of positioning of the cylinder 12 and the protruding portion 23. That is, fitting between the cylinder 12 and the fitting portion 101 is not limited to tight fitting, and may be clearance fitting. Here, the tolerance range of positioning of the cylinder 12 and the protruding portion 23 is a range in which the cylinder 12 can be aligned with the outer cylinder 14 and can be positioned in the radial direction.

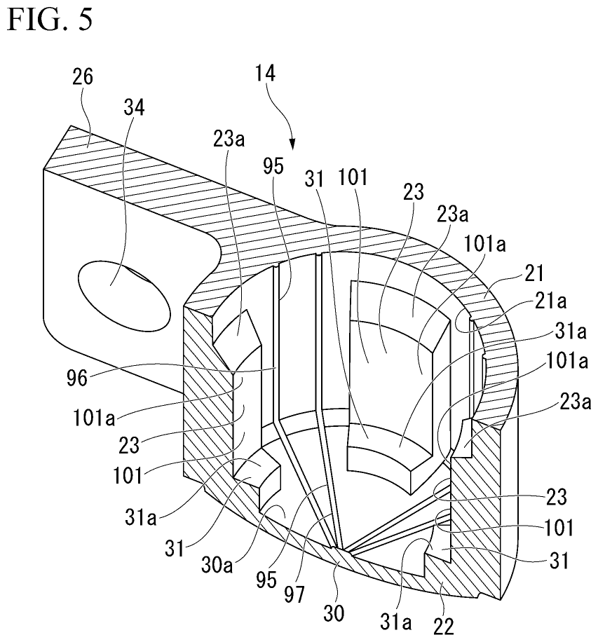

As shown in FIG. 5, some of the plurality of protruding portions 23 have an end surface 23a provided on one end side in the axial direction. Each of the end surface 23a is disposed on a tapered surface, around the central axis of the side wall portion 21, which extends from the inner end surface 101a of the fitting portion 101 of the protruding portion 23 toward the inner peripheral surface 21a of the side wall portion 21, that is, toward the inner peripheral surface of the outer cylinder 14. The tapered surface is inclined to be closer to the other end side in the axial direction toward the inner end surface 101a side of the fitting portion 101.

As shown in FIG. 2, the centers of the end surfaces 23a in the axial direction are aligned. In other words, the centers of the end surfaces 23a in the axial direction are disposed at positions equidistant from the lowermost position of the bottom surface 30a on the other end side in the axial direction. The end surface 23a is a tapered surface extending from the fitting portion 101 of the protruding portion 23 toward the inner peripheral surface of the outer cylinder 14.

The bottom portion 22 of the outer cylinder 14 has the contact portion 31 with which an end portion 102 (other end side end portion of the cylinder) of the body 42, which is an end portion on the other end side in the axial direction of the cylinder 12, comes into contact. The end portion 102 of the cylinder 12 has a contact surface 42a and an end surface 42b. As shown in FIG. 5, the contact portion 31 is formed continuously with the protruding portion 23 to protrude inward in the radial direction of the side wall portion 21 from the protruding portion 23, and is formed to extend to one end side in the axial direction from the bottom surface 30a of the bottom portion body portion 30. In other words, the contact portion 31 is formed to extend to one end side in the axial direction in the bottom portion 22. In the outer cylinder 14, a plurality of the contact portions 31, specifically four contact portions 31 as many as the protruding portions 23, are provided apart from each other at an equal interval in the circumferential direction of the side wall portion 21, and are disposed so that the positions of the contact portions 31 are aligned with the protruding portions 23. End surfaces 31a of the plurality of contact portions 31 on one end side in the axial direction are disposed on the same plane orthogonal to the central axis of the side wall portion 21. The contact portions 31 may not be provided at four locations, and may be provided at two or more locations.

In the outer cylinder 14, a plurality of ribs 95 are formed on the side wall portion 21 and the bottom portion body portion 30 so as to be continuously extend from the side wall portion 21 to the bottom portion body portion 30, and are disposed between the protruding portions 23 adjacent to each other and between the contact portions 31 continuous with the protruding portions 23 and adjacent to each other. The rib 95 has a projection portion 96 protruding inward in the radial direction from the inner peripheral surface 21a of the side wall portion 21, and a projection portion 97 serving as a projection portion according to the present invention which protrudes to one end side in the axial direction from the bottom surface 30a of the bottom portion body portion 30. The projection portion 96 formed on the side wall portion 21 extends along the central axis of the side wall portion 21. The projection portion 97 formed on the bottom portion body portion 30 extends along the radial direction of the bottom portion body portion 30. The plurality of projection portions 97 provided in the bottom portion 22 radially extends from the center in the radial direction of the bottom portion body portion 30. The inner end surfaces 101a of the fitting portions 101 of the plurality of protruding portions 23 are disposed inside the whole projection portions 96 in the radial direction of the side wall portion 21. The end surfaces 31a of the plurality of contact portions 31 are disposed closer to one end side in the axial direction than the whole projection portions 97.

As shown in FIG. 2, in the outer cylinder 14, the inner end surfaces 101a of the fitting portions 101 of the plurality of protruding portions 23 come into contact with an outer peripheral surface 41a of the cylinder body 41 of the cylinder 12, and thereby the cylinder 12 is positioned not to be movable with respect to the outer cylinder 14 in the radial direction. In addition, in the outer cylinder 14, the end surfaces 31a of the plurality of contact portions 31 come into contact with the end portion 102 of the body 42 of the cylinder 12, and thereby the cylinder 12 is positioned not to be movable in the axial direction.

In this state, the protruding portion 23 of the outer cylinder 14 protrudes inward in the radial direction of the cylinder 12 from the inner peripheral surface of the outer cylinder 14. In addition, the protruding portion 23 extends in the axial direction of the cylinder 12 from the bottom portion 22 of the outer cylinder 14. In addition, the outer cylinder 14 is provided with the plurality of protruding portions 23 apart from each other at an equal interval in the circumferential direction of the cylinder 12. An inner end portion of the protruding portion 23 in the radial direction of the cylinder 12 is the fitting portion 101 to which the outer periphery of the cylinder 12 is fitted. The same tapered surface on which the inner end surfaces 101a of the plurality of fitting portions 101 are disposed is inclined to be closer to the central axis of the cylinder 12 toward the bottom portion 22 side. The inner end surfaces 101a of the plurality of fitting portions 101 are disposed at positions equidistant from the central axis of the cylinder 12. The plurality of inner end surfaces 101a come into contact with the outer peripheral surface 41a of the cylinder body 41 of the cylinder 12, and thereby the cylinder 12 is positioned not to be movable with respect to the outer cylinder 14 in the radial direction of the cylinder 12. In order to position the cylinder 12 in the radial direction, it is preferable to provide at least three protruding portions 23 at an equal interval in the circumferential direction of the cylinder 12.

In addition, in this state, the contact portion 31 is formed continuously with the protruding portion 23 to protrude inward in the radial direction of the cylinder 12 from the protruding portion 23, and is formed to extend to one end side in the axial direction of the cylinder 12 from the bottom surface 30a of the bottom portion body portion 30. In other words, the contact portion 31 is formed to extend to one end side in the axial direction of the cylinder 12 in the bottom portion 22. In the outer cylinder 14, the plurality of contact portions 31 are provided apart from each other at an equal interval in the circumferential direction of the cylinder 12. The end surfaces 31a of the plurality of contact portions 31 on one end side in the axial direction are disposed on the same plane orthogonal to the central axis of the cylinder 12.

In addition, in this state, a passage 121 is formed between the protruding portions 23 and the contact portions 31 which are adjacent to each other in the circumferential direction of the cylinder 12, a chamber 122 is formed between the body 42 and the bottom portion body portion 30, a chamber 123 is formed between the cylinder 12 and the side wall portion 21 of the outer cylinder 14, and the passage 121 causes the chamber 122 to always communicate with the chamber 123. A plurality of the passages 121, specifically four passages 121, the chamber 122, and the chamber 123 form the reservoir chamber 13. The rib 95 provided between the protruding portions 23 and between the contact portions 31 is formed to protrude inward in the radial direction of the cylinder 12 from the inner peripheral surface 21a. The plurality of projection portions 97 radially extending in the radial direction of the cylinder 12 are formed on the bottom surface 30a of the bottom portion 22. The contact portion 31 is provided between the projection portions 97 which are adjacent to each other in the circumferential direction of the cylinder 12. The protruding portion 23 is provided between the projection portions 96 which are adjacent to each other in the circumferential direction of the cylinder 12.

Here, as shown in FIG. 3, in the body 42 of the cylinder 12, the contact surface 42a of the end portion 102 which comes into contact with the end surfaces 31a of the contact portions 31 is formed on the same plane over an entire periphery of the body 42. The contact surface 42a is formed on a plane the same as that of the end surface 42b provided inside the contact surface 42a in the radial direction and on the other end side in the axial direction. The inner end surface 42b of the body 42 comes into contact with the disc valve 85 inside in the radial direction, and an inner peripheral side of the disc valve 85 is pressed against the inner end surface 42b inside in the radial direction by the fastener 88.

The outer cylinder 14 is formed by gravity casting in which molten metal is poured into a mold by gravity. In the mold, a cavity forming the bottom portion 22 side is disposed above a cavity forming the side wall portion 21 side. In the mold, a core for forming the inner peripheral surface 21a of the side wall portion 21, the plurality of protruding portions 23, the plurality of contact portions 31, and the bottom surface 30a of the bottom portion body portion 30 is disposed. A plurality of grooves for venting gas inside the cavity when the molten metal is poured into the cavity are formed in the core to extend in an upward-downward direction. The ribs 95 are formed by solidifying the molten metal poured into the grooves. In other words, the rib 95 is a transfer mark of the groove for venting the gas during casting.

Next, a method of manufacturing the shock absorber 10 of the present embodiment will be described.

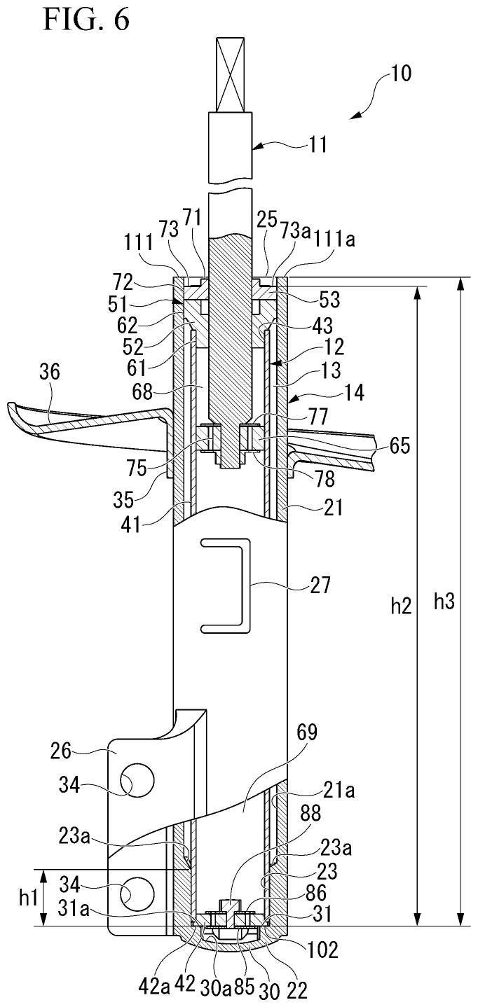

As shown in FIG. 6, the outer cylinder 14 is formed by gravity casting as described above in a state before the crimping portion 55 is formed in the opening portion 25 (hereinafter, referred to as before crimping). Before the crimping portion 55 is formed, the crimping portion 55 has a cylindrical shape in which the side wall portion 21 is extended as it is.

Then, in an assembling step, the cylinder body 41 is fitted to the body 42 in a state where the disc valves 85 and 86 are attached to the body 42 by the fastener 88, and thereby the cylinder 12 is assembled in advance. In addition, the piston 65 in a state of being attached to the rod 11 together with the disc valves 77 and 78 is fitted into the cylinder 12. Furthermore, the rod guide 52 is fitted to the cylinder fitting portion 61 on the other end side in the axial direction of the cylinder 12 so that the rod 11 is inserted into the rod guide 52, and the seal member 53 is disposed on the other end side in the axial direction of the rod guide 52 so that the rod 11 is inserted into the seal member 53. A sub-assembly of these components, which is separately assembled in this state, is inserted into the outer cylinder 14 before crimping through the opening portion 25 while inserting the body 42 of the sub-assembly first. Then, the rod guide 52 and the seal member 53 are fitted to the inner peripheral surface of the outer cylinder 14 before crimping, and the contact surface 42a of the body 42 is brought into contact with the end surfaces 31a of the contact portions 31.

After the above assembling step, while the seal member 53, the rod guide 52, and the cylinder 12 are pressed against the bottom portion 2 side with a predetermined axial force, and the crimping portion 55 is formed on the opening portion 25 side of the outer cylinder 14. In this manner, as shown in FIG. 1, a fixing step of fixing the seal member 53 and the rod guide 52 at specified positions of the outer cylinder 14 is performed. The specified positions of the outer cylinder 14 are positions where the seal member 53 and the rod guide 52 are disposed in the shock absorber 10 as a finished product.

Here, h3 is defined as a length from the end surface 31a of the contact portion 31 to an end surface 111a of an end portion 111 (one end side end portion of the outer cylinder) on one end side in the axial direction of the outer cylinder 14 before crimping, and h2 is defined as a length from the contact surface 42a of the end portion 102 on the other end side in the axial direction of the cylinder 12 to the end surface 73a of the end portion 73 on one end side in the axial direction of the outer peripheral side seal portion 72 of the seal member 53. In the assembling step before the fixing step, as shown in FIG. 6, in which the cylinder 12 and the closing member 51 including the rod guide 52 and the seal member 53 are assembled into the outer cylinder 14 before crimping, h3 is longer than h2.

In addition, when h3 is defined as the length from the end surface 31a of the contact portion 31 of the bottom portion 22 to the end surface 111a of the end portion 111 on one end side in the axial direction of the outer cylinder 14, and h2 is defined as the length from the contact surface 42a of the end portion 102 on the other end side in the axial direction of the cylinder 12 to the end surface 73a of the end portion 73 on one end side in the axial direction of the outer peripheral side seal portion 72 of the seal member 53, a length h1 from the end surface 23a on one end side in the axial direction of the protruding portion 23 to the end surface 31a of the contact portion 31 is longer than a difference between h3 and h2. That is, a relationship is h1>h3−h2.

Therefore, in a state where the end portion 102 of the body 42 of the cylinder 12 is in contact with the end surface 23a on one end side in the axial direction of the protruding portion 23, the end surface 73a of the outer peripheral side seal portion 72 of the seal member 53 is located on a side opposite to the bottom portion 22 from the end surface 111a on one end side in the axial direction of the outer cylinder 14 before crimping.

Therefore, it is physically difficult to form the crimping portion 55 in the outer cylinder 14.

Patent Document 1 described above discloses a shock absorber having a cylinder and an outer cylinder that covers the cylinder. In the shock absorber, a crimping portion is formed on a side opposite to a lower cap of the outer cylinder, and the cylinder, a valve case, and a rod guide are held between the crimping portion and the lower cap. Here, in order to position the cylinder in the radial direction with respect to a bottom portion side of the outer cylinder while forming a reservoir chamber, it is conceivable that a plurality of protruding portions protruding inward in the radial direction are formed on the bottom portion side of the outer cylinder.

However, in a case where the protruding portions are formed in this way, when the cylinder is assembled to the outer cylinder, the cylinder may be stopped by coming into contact with the protruding portions on a side opposite to the bottom portion. When the outer cylinder is crimped in this state, there may be a defect in the assembly of the cylinder to the outer cylinder.

In contrast, in the first embodiment, as shown in FIG. 6, in the assembling step before the fixing step, in which the cylinder 12 and the closing member 51 including the rod guide 52 and the seal member 53 are assembled into the outer cylinder 14 before crimping, the length h1 from the end surface 23a on one end side in the axial direction of the protruding portion 23 to the end surface 31a of the contact portion 31 is longer than the difference between h3 and h2, where h3 is defined as the length from the end surface 31a of the contact portion 31 of the bottom portion 22 to the end surface 111a of the end portion 111 on one end side in the axial direction of the outer cylinder 14, and h2 is defined as the length from the contact surface 42a of the end portion 102 on the other end side in the axial direction of the cylinder 12 to the end surface 73a of the end portion 73 on one end side in the axial direction of the outer peripheral side seal portion 72 of the seal member 53.

Therefore, in a state where the end portion 102 of the body 42 of the cylinder 12 is in contact with the end surface 23a on one end side in the axial direction of the protruding portion 23, the end surface 73a of the outer peripheral side seal portion 72 of the seal member 53 is located on a side opposite to the bottom portion 22 from the end surface 111a on one end side in the axial direction of the outer cylinder 14 before crimping.

Therefore, it is physically difficult to form the crimping portion 55 in the outer cylinder 14. Therefore, defective assembly of the cylinder 12, the rod guide 52, and the seal member 53 to the outer cylinder 14 can be suppressed.

In addition, on the bottom portion 22 side of the outer cylinder 14, the cylinder 12 is aligned with the outer cylinder 14 by the plurality of protruding portions 23 and is positioned in the radial direction to restrict a deviation in the radial direction, and on the opening portion 25 side, the cylinder 12 is aligned and positioned in the radial direction by the rod guide 52. Accordingly, the cylinder 12 can properly and stably be disposed with respect to the outer cylinder 14. Therefore, the cylinder 12 is less likely to deviate with respect to the outer cylinder 14 when a lateral force is input to the shock absorber 10, and stable damping force characteristics can be obtained.

In addition, the cylinder 12 includes the cylinder body 41 and the body 42 provided in the other end portion of the cylinder body 41 in the axial direction. Therefore, the body 42 can stably come into contact with the contact portion 31.

In addition, by forming the protruding portions 23 and the contact portions 31 in the outer cylinder 14, the passages 121, which cause the chamber 122 between the body 42 and the bottom portion body portion 30 to always communicate with the chamber 123 between the cylinder 12 and the side wall portion 21 of the outer cylinder 14 to form the reservoir chamber 13, are formed in the outer cylinder 14. Therefore, it is no longer necessary to provide a leg portion for forming a passage for causing the chamber 122 to communicate with the chamber 123 in the body 42. As a result, the contact surface 42a of the body 42 that comes into contact with the contact portion 31 can be formed on a plane the same as the end surface 42b provided inside the contact surface 42a in the radial direction and on the other end side in the axial direction. In this manner, a difference between a thickness of the body 42 on the contact surface 42a side and a thickness of the body 42 on the end surface 42b side positioned inside the contact surface 42a in the radial direction can be reduced. Therefore, the body 42 can be easily manufactured. For example, when the body 42 is molded by sintering, it is possible to suppress a decrease in density of the body 42 on the contact surface 42a side. Therefore, even when a strong axial force is applied to the contact surface 42a side of the body 42 between the cylinder body 41 and the contact portion 31 via the seal member 53 and the rod guide 52 at the time of forming the crimping portion 55 of the outer cylinder 14, it is possible to suppress damage to the body 42.

In addition, the contact portion 31 is formed continuously with the protruding portion 23 to protrude inward in the radial direction of the cylinder 12 from the protruding portion 23, and is formed to extend to one end side in the axial direction of the cylinder 12 in the bottom portion 22. Therefore, the outer cylinder 14 can be easily manufactured.

In addition, the end surface 23a on one end side in the axial direction of the protruding portion 23 is a tapered surface extending from the fitting portion 101 of the protruding portion 23 toward the inner peripheral surface of the outer cylinder 14. Accordingly, the body 42 of the cylinder 12 is less likely to be stopped by coming into contact with the end surface 23a of the protruding portion 23. Therefore, it is easy to properly assemble the cylinder 12 to the outer cylinder 14.

In addition, the protruding portions 23 are provided at four locations which are three or more locations. Accordingly, the cylinder 12 can more properly be positioned in the radial direction with respect to the outer cylinder 14.

In addition, in order to vent the gas during casting, the bottom surface 30a of the bottom portion 22 has the plurality of projection portions 97 radially extend in the radial direction of the cylinder 12, but the contact portion 31 is provided between the projection portions 97 which are adjacent to each other in the circumferential direction of the cylinder 12. Therefore, the cylinder 12 can be brought into contact with the contact portion 31 while avoiding the projection portions 97. Therefore, the cylinder 12 can come into surface contact with the outer cylinder 14 and can be stably seated on the outer cylinder 14.

In addition, in order to vent the gas during casting, the inner peripheral surface 21a of the side wall portion 21 also has the plurality of projection portions 96 extending in the axial direction of the cylinder 12, but the protruding portion 23 is provided between the projection portions 96 which are adjacent to each other in the circumferential direction of the cylinder 12. Therefore, the cylinder 12 can be fitted to the plurality of protruding portions 23 while avoiding the projection portions 96. Therefore, the cylinder 12 can be stably positioned in the radial direction with respect to the outer cylinder 14.

### Second Embodiment

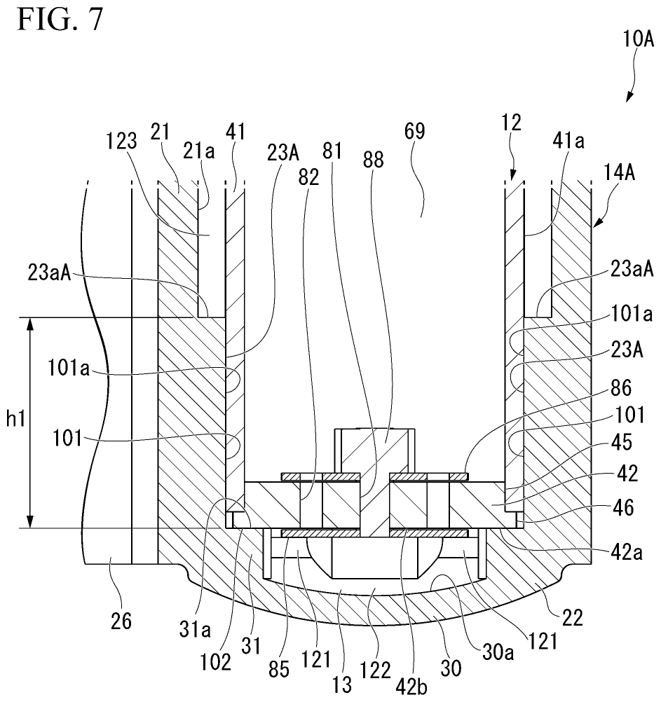

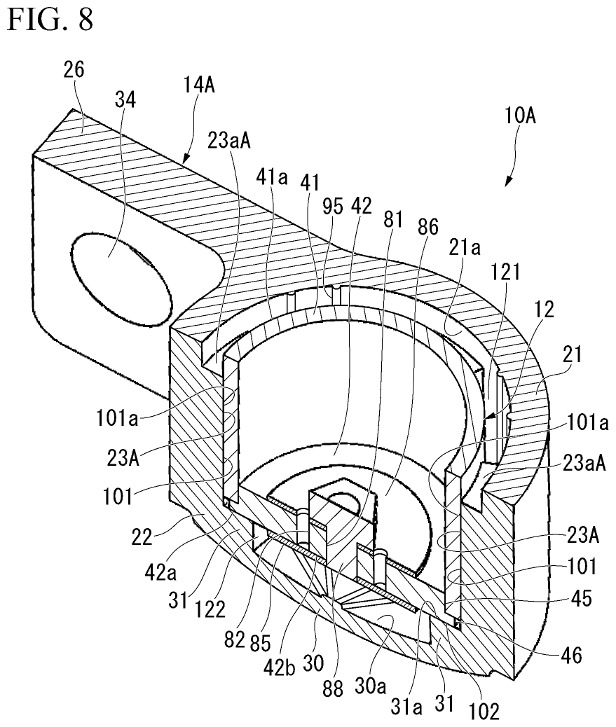

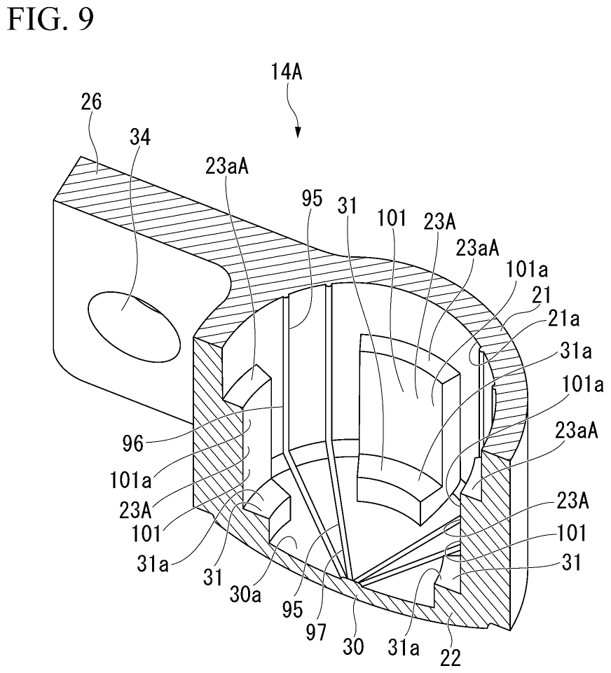

Next, a second embodiment will be described mainly with reference to FIGS. 7 to 9, focusing on elements different from those of the first embodiment. The same name and the same reference numerals will be assigned to the elements common to those of the first embodiment.

In a shock absorber 10A of the second embodiment, an outer cylinder 14A partially different from the outer cylinder 14 of the first embodiment is used. The outer cylinder 14A has a plurality of protruding portions 23A, specifically four protruding portions 23A, which are partially different from the protruding portions 23 of the first embodiment, and the protruding portion 23A has an end surface 23aA provided on one end side in the axial direction, which is different from the end surface 23a of the first embodiment. All of the end surfaces 23aA have a planar shape disposed on the same plane orthogonal to the central axis of the side wall portion 21. Therefore, all of the end surfaces 23aA are disposed at positions equidistant from the lowermost position of the bottom surface 30a on the other end side in the axial direction. In the second embodiment, the contact portions 31 may also not be provided at four locations, and may be provided at two or more locations.

In the shock absorber 10A of the second embodiment, h3 is also defined as the length from the end surface 31a of the contact portion 31 of the bottom portion 22 to the end surface 111a of the end portion 111 on one end side in the axial direction of the outer cylinder 14A, and h2 is also defined as the length from the contact surface 42a of the end portion 102 on the other end side in the axial direction of the cylinder 12 to the end surface 73a of the end portion 73 on one end side in the axial direction of the outer peripheral side seal portion 72 of the seal member 53. In this case, in the assembling step before the fixing step, in which the cylinder 12, the rod guide 52, and the seal member 53 are assembled into the outer cylinder 14A before crimping, the length h1 from the end surface 23aA on one end side in the axial direction of the protruding portion 23A to the end surface 31a of the contact portion 31 is longer than the difference between h3 and h2. That is, a relationship is h1>h3−h2.

Therefore, in a state where the end portion 102 of the body 42 of the cylinder 12 is in contact with the end surface 23aA on one end side in the axial direction of the protruding portion 23A, the end surface 73a of the outer peripheral side seal portion 72 of the seal member 53 is located on a side opposite to the bottom portion 22 from the end surface 111a on one end side in the axial direction of the outer cylinder 14A before crimping. Therefore, it is physically difficult to form the crimping portion 55 in the outer cylinder 14A.

### Third Embodiment

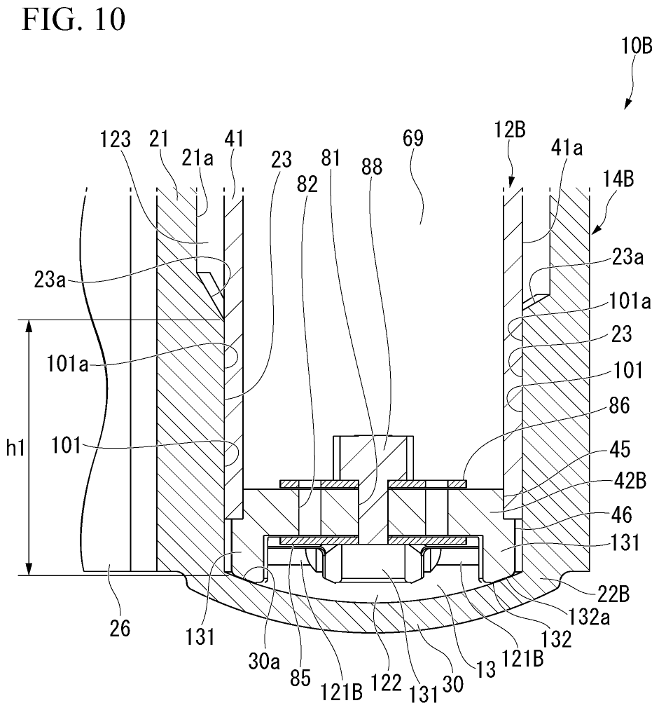

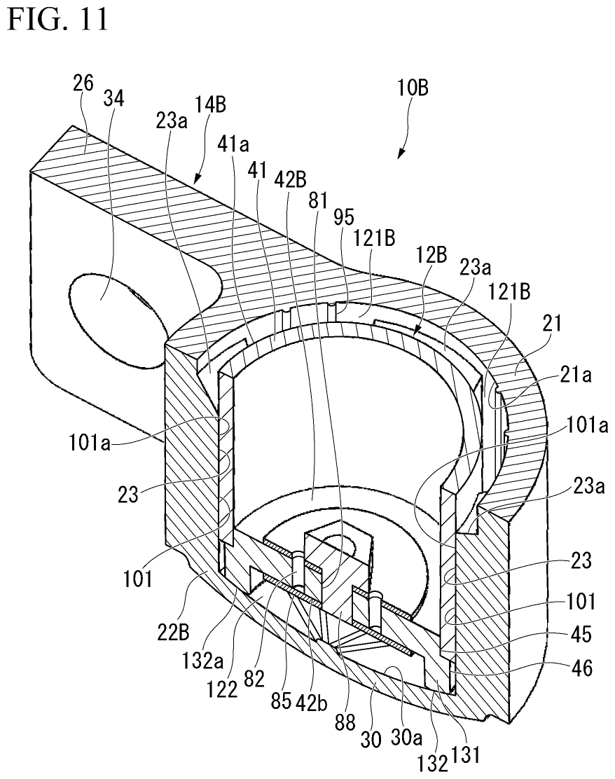

Next, a third embodiment will be described mainly with reference to FIGS. 10 and 11, focusing on elements different from those of the first embodiment. The same name and the same reference numerals will be assigned to the elements common to those of the first embodiment.

In a shock absorber 10B of the third embodiment, an outer cylinder 14B partially different from the outer cylinder 14 of the first embodiment is used. A bottom portion 22B of the outer cylinder 14B is partially different from the bottom portion 22 of the first embodiment. The bottom portion 22B does not have the contact portion 31 of the first embodiment, and includes only the bottom portion body portion 30. In the bottom portion 22B, the bottom portion body portion 30 serves as the contact portion.

In the shock absorber 10B of the third embodiment, a cylinder 12B partially different from the cylinder 12 of the first embodiment is used. The cylinder 12B has a body 42B partially different from the body 42 of the first embodiment. The outer peripheral side of the body 42B has a leg portion 131 protruding in the axial direction to a side opposite to the small diameter portion 45 from the large diameter portion 46. A plurality of the leg portions 131, specifically four leg portions 131 as many as the protruding portions 23, are provided apart from each other at an equal interval in the circumferential direction of the body 42B. End portions 132 (other end side end portion of the cylinder) of the leg portions 131 of the cylinder 12B on a side opposite to the small diameter portion 45 come into contact with the bottom portion body portion 30.

Then, the cylinder 12B in a state where the body 42B is attached to the cylinder body 41 is disposed inside the outer cylinder 14B so that the positions of the leg portions 131 in the circumferential direction are aligned with the protruding portions 23 of the outer cylinder 14B. In this case, the cylinder 12B is in contact with the bottom surface 30a of the bottom portion body portion 30, more specifically, in contact with contact surfaces 132a of the end portions 132 on the other end side in the axial direction of the leg portions 131. A passage 121B is formed between the protruding portions 23 which are adjacent to each other in the circumferential direction of the cylinder 12B and the leg portion 131 which are aligned with the protruding portions 23 and are adjacent to each other in the circumferential direction of the cylinder 12B, and the passage 121B causes the chamber 122 between the body 42B and the bottom portion body portion 30 to always communicate with the chamber 123 between the cylinder 12B and the side wall portion 21 of the outer cylinder 14B. A plurality of the passages 121B, specifically four passages 121B, the chamber 122, and the chamber 123 form the reservoir chamber 13.

Here, in order to easily align the positions of the leg portions 131 with the protruding portions 23 of the outer cylinder 14B, recess portions which are recessed from the bottom surface 30a and to which the leg portions 131 are fitted may be formed as many as the leg portions 131 in the bottom portion body portion 30.

In the shock absorber 10B of the third embodiment, h3 is defined as a length (shortest distance) from a position of the bottom surface 30a of the bottom portion body portion 30 with which the leg portion 131 comes into contact, to the end surface 111a of the end portion 111 on one end side in the axial direction of the outer cylinder 14, and h2 is defined as a length (shortest distance) from the contact surface 132a on the other end side in the axial direction of the leg portion 131 of the cylinder 12 to the end surface 73a of the end portion 73 on one end side in the axial direction of the outer peripheral side seal portion 72 of the seal member 53. In this case, in the assembling step before the fixing step, in which the cylinder 12B, the rod guide 52, and the seal member 53 are assembled into the outer cylinder 14B before crimping, a length (shortest distance) h1 from the end surface 23a on one end side in the axial direction of the protruding portion 23 to the position of the bottom surface 30a of the bottom portion body portion 30 with which the leg portion 131 comes into contact is longer than the difference between h3 and h2. That is, a relationship is h1>h3−h2.

Therefore, in a state where the leg portion 131 of the body 42B of the cylinder 12B is in contact with the end surface 23a on one end side in the axial direction of the protruding portion 23, the end surface 73a of the outer peripheral side seal portion 72 of the seal member 53 is located on a side opposite to the bottom portion 22B from the end surface 111a on one end side in the axial direction of the outer cylinder 14B before crimping. Therefore, it is physically difficult to form the crimping portion 55 in the outer cylinder 14B.

### Fourth Embodiment

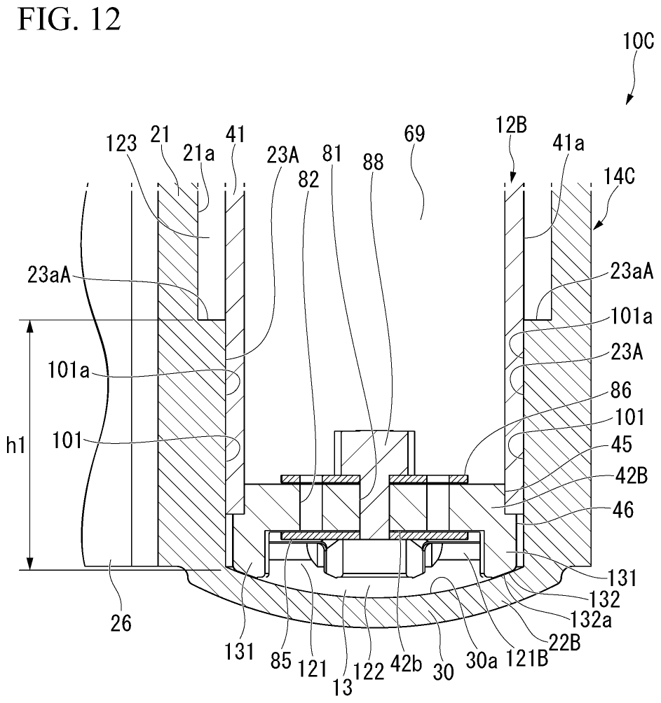

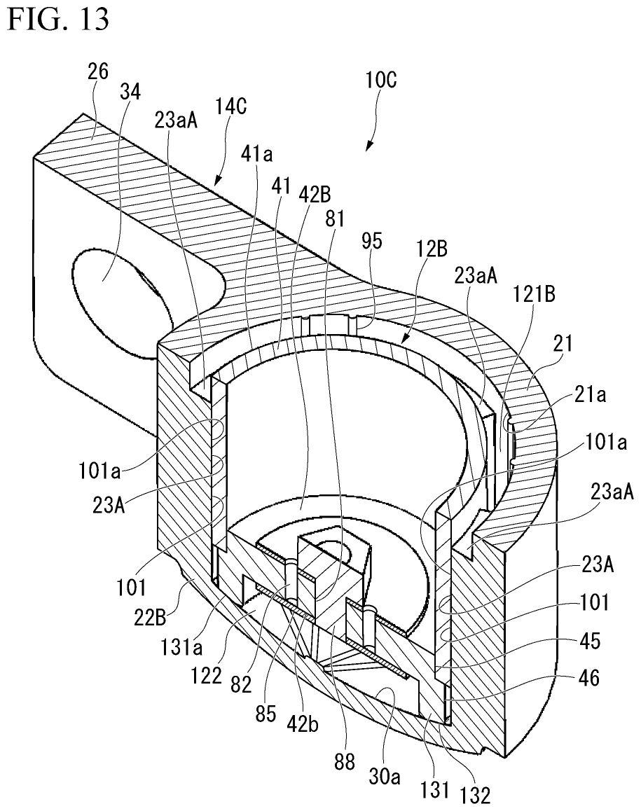

Next, a fourth embodiment will be described mainly with reference to FIGS. 12 and 13, focusing on elements different from those of the third embodiment. The same name and the same reference numerals will be assigned to the elements common to those of the third embodiment.

In a shock absorber 10C of the fourth embodiment, an outer cylinder 14C partially different from the outer cylinder 14B of the third embodiment is used. The outer cylinder 14C has the plurality of protruding portions 23A, specifically four protruding portions 23A, as in the second embodiment. All of the end surfaces 23aA on one end side in the axial direction of the protruding portions 23A have a planar shape disposed on the same plane orthogonal to the central axis of the side wall portion 21.

In the shock absorber 10C of the fourth embodiment, h3 is also defined as the length (shortest distance) from the position of the bottom surface 30a of the bottom portion body portion 30 with which the leg portion 131 comes into contact, to the end surface 111a of the end portion 111 on one end side in the axial direction of the outer cylinder 14, and h2 is also defined as the length (shortest distance) from the contact surface 132a on the other end side in the axial direction of the leg portion 131 of the cylinder 12 to the end surface 73a of the end portion 73 on one end side in the axial direction of the outer peripheral side seal portion 72 of the seal member 53. In this case, in the assembling step before the fixing step, in which the cylinder 12B, the rod guide 52, and the seal member 53 are assembled into the outer cylinder 14C before crimping, the length (shortest distance) h1 from the end surface 23aA on one end side in the axial direction of the protruding portion 23A to the position of the bottom surface 30a of the bottom portion body portion 30 with which the leg portion 131 comes into contact is longer than the difference between h3 and h2. That is, a relationship is h1>h3−h2.

A configuration in which the outer cylinder 14 of each of the above-described embodiments is formed by gravity casting in which molten metal is poured into a mold by gravity has been described as an example. However, a so-called raw material whose shape is more freely formed by die casting, forging, a 3D printer, and resin molding may be used. In this case, the rib 95 is not formed in the outer cylinder 14.

Therefore, in a state where the contact surface 132a of the end portion 132 on the other end side in the axial direction of the leg portion 131 of the body 42B of the cylinder 12B is in contact with the end surface 23aA on one end side in the axial direction of the protruding portion 23A, the end surface 73a of the outer peripheral side seal portion 72 of the seal member 53 is located on a side opposite to the bottom portion 22 from the end surface 111a on one end side in the axial direction of the outer cylinder 14 before crimping. Therefore, it is physically difficult to form the crimping portion 55 in the outer cylinder 14.

According to a first aspect of the embodiments described above, the shock absorber includes a rod having one end side protruding outward, a cylinder having a cylindrical shape, an outer cylinder having a bottom portion provided on the other end side, disposed on an outer peripheral side of the cylinder to form a reservoir chamber between the cylinder and the outer cylinder, a closing member that closes an opening of the cylinder on one end side and an opening of the outer cylinder on one end side, a plurality of protruding portions extending in an axial direction of the cylinder from the bottom portion, protruding inward in a radial direction of the cylinder from an inner peripheral surface of the outer cylinder, and provided apart from each other in a circumferential direction of the cylinder, and a contact portion provided in the bottom portion, and with which the other end side end portion of the cylinder comes into contact. The protruding portion includes a fitting portion to which an outer periphery of the cylinder is fitted. When the cylinder and the closing member are assembled into the outer cylinder, a length from the contact portion to one end side end portion of the outer cylinder is longer than a length from the other end side end portion of the cylinder to one end side end portion on an outer peripheral side of the closing member, and a length from one end side end surface of the protruding portion to the contact portion is longer than a difference between the length from the contact portion of the bottom portion to one end side end portion of the outer cylinder and the length from the other end side end portion of the cylinder to one end side end portion on the outer peripheral side of the closing member. In this manner, defective assembly can be suppressed.

According to a second aspect, in the first aspect, the cylinder includes a cylinder body and a body provided in the other end side end portion of the cylinder body. In this manner, the body can stably come into contact with the contact portion.

According to a third aspect, in the second aspect, a surface of the body which comes into contact with the contact portion is formed on a plane the same as that of the other end side surface of the body located inside in the radial direction.

According to a fourth aspect, in any one of the first to third aspects, the contact portion is formed continuously with the protruding portion to protrude inward in the radial direction of the cylinder from the protruding portion, and is formed to extend to one end side of the cylinder in the bottom portion. In this manner, it is easy to manufacture the body.

According to a fifth aspect, in any one of the first to fourth aspects, one end side end surface of the protruding portion is a tapered surface extending from the fitting portion of the protruding portion toward the inner peripheral surface of the outer cylinder. Accordingly, the cylinder is less likely to be in a stopped state after coming into contact with the end surface on one end side of the protruding portion. Therefore, it is easy to properly assemble the cylinder to the outer cylinder.

According to a sixth aspect, in any one of the first to fifth aspects, the protruding portions are provided at three locations. In this manner, the cylinder can more properly be positioned in the radial direction with respect to the outer cylinder.

According to a seventh aspect, in any one of the first to sixth aspects, a plurality of projection portions radially extending in the radial direction of the cylinder are formed on a bottom surface of the bottom portion, and the contact portion is provided between the projection portions adjacent to each other in the circumferential direction of the cylinder. In this manner, the cylinder can be avoided from the projection portion, and can be brought into contact with the contact portion. Therefore, the cylinder can stably be seated on the outer cylinder.

### Industrial Applicability

According to the shock absorber, defective assembly can be suppressed.

### Reference Signs List

10, 10A, 10B, 10C: Shock absorber
12, 12B: Cylinder
13: Reservoir chamber
14, 14A, 14B, 14C: Outer cylinder
18: Hose bracket (mounting member)
21a: Inner peripheral surface of side wall portion
23, 23A: Protruding portion
23a, 23aA: end surface (one end side end surface of protruding portion)
30: Bottom portion body portion (contact portion)
31: Contact portion
41: Cylinder body
42, 42B: Body
51: Closing member
73: End portion (one end side end portion on outer peripheral side of closing member)
97: Projection portion
101: Fitting portion
102: End portion (the other end side end portion of cylinder)
111: End portion (one end side end portion of outer cylinder)
131: Leg portion
132: End portion (the other end side end portion of cylinder)

1. A shock absorber comprising:
a rod having one end side protruding outward;
a cylinder having a cylindrical shape;
an outer cylinder having a bottom portion provided on the other end side, disposed on an outer peripheral side of the cylinder to form a reservoir chamber between the cylinder and the outer cylinder;
a closing member that closes an opening of the cylinder on one end side and an opening of the outer cylinder on one end side;
a plurality of protruding portions extending in an axial direction of the cylinder from the bottom portion, protruding inward in a radial direction of the cylinder from an inner peripheral surface of the outer cylinder, and provided apart from each other in a circumferential direction of the cylinder; and
a contact portion provided in the bottom portion, and with which the other end side end portion of the cylinder comes into contact,
wherein the protruding portion includes a fitting portion to which an outer periphery of the cylinder is fitted,
when the cylinder and the closing member are assembled into the outer cylinder, a length from the contact portion to one end side end portion of the outer cylinder is longer than a length from the other end side end portion of the cylinder to one end side end portion on an outer peripheral side of the closing member, and
a length from one end side end surface of the protruding portion to the contact portion is longer than a difference between the length from the contact portion of the bottom portion to one end side end portion of the outer cylinder and the length from the other end side end portion of the cylinder to one end side end portion on the outer peripheral side of the closing member, and is smaller than a length from one end side end portion of the protruding portion to the other end side end portion of the contact portion.

2. The shock absorber according to claim 1,
wherein the cylinder includes a cylinder body and a body provided in the other end side end portion of the cylinder body.

3. The shock absorber according to claim 2,
wherein a surface of the body which comes into contact with the contact portion is formed on a plane the same as that of the other end side surface of the body located inside in the radial direction.

4. The shock absorber according to claim 1,
wherein the contact portion is formed continuously with the protruding portion to protrude inward in the radial direction of the cylinder from the protruding portion, and is formed to extend to one end side of the cylinder in the bottom portion.

5. The shock absorber according to claim 1,
wherein one end side end surface of the protruding portion is a tapered surface extending from the fitting portion of the protruding portion toward the inner peripheral surface of the outer cylinder.

6. The shock absorber according to claim 1,
wherein the protruding portions are provided at three locations.

7. The shock absorber according to claim 1,
wherein a plurality of projection portions radially extending in the radial direction of the cylinder are formed on a bottom surface of the bottom portion, and
the contact portion is provided between the projection portions adjacent to each other in the circumferential direction of the cylinder.
